(19) United States
(12) Patent Application Publication
(10) Pub. No.: US 2026/0258702 A1
(43) Pub. Date: Sep. 3, 2026

(54) LADDER AND LADDER TOP

(71) Applicant: Werner Co., Itasca, IL (US)

(72) Inventors: Claire ARMENOFF, Montgomery, IL (US); Michael T. MELTON, Glen Ellyn, IL (US); Weston VAN WAMBEKE, Saverna Park, MD (US)

(21) Appl. No.: 19/656,300

(22) Filed: Apr. 23, 2026

Related U.S. Application Data
(63) Continuation of application No. 18/070,265, filed on Nov. 28, 2022, now Pat. No. 12,631,067.
(60) Provisional application No. 63/284,599, filed on Nov. 30, 2021.

(51) Int. Cl. E06C 7/14; E06C 7/48

(52) U.S. Cl. CPC E06C 7/14; E06C 7/48

(57) ABSTRACT

A ladder top having a front side flange, a rear side flange, a right side flange and a left side flange. The right side flange has a right metal plate through which right fasteners extend into a right front rail and a right rear rail. The left side flange having a left metal plate through which left fasteners extend into a left front rail and a left rear rail. A ladder top with passages for carabiners. Ladders with metal plates on the side flanges, or with passages for carabiners on the ladder top of the ladder. Methods of using a ladder. A method of producing a ladder.

### CROSS-REFERENCE TO RELATED APPLICATIONS

This is a nonprovisional of U.S. provisional patent application Ser. No. 63/284,599 filed Nov. 30, 2021, incorporated by reference herein.

### FIELD OF THE INVENTION

The present invention is related to ladder tops of ladders which have features to which tools or objects may be attached. (As used herein, references to the “present invention” or “invention” relate to exemplary embodiments and not necessarily to every embodiment encompassed by the appended claims.) More specifically, the present invention is related to ladder tops of ladders which have metal plates to which tools or objects that have magnets may be attached and/or have passages to which hooks or carabiners may be attached.

### BACKGROUND OF THE INVENTION

This section is intended to introduce the reader to various aspects of the art that may be related to various aspects of the present invention. The following discussion is intended to provide information to facilitate a better understanding of the present invention. Accordingly, it should be understood that statements in the following discussion are to be read in this light, and not as admissions of prior art.

Whenever a ladder is used, it is very often that tools or objects are required to assist the user in whatever work the user is performing. To have these tools or objects readily and safely available to the user so the user doesn't have to climb up and down the ladder when they are needed, or risk putting himself or herself in a precarious position to reach them is an important requirement. To accommodate this, ladder tops have slots or bins or openings or magnets to assist users in making these tools or objects assessable when the user has climbed onto the ladder. However, there are some tools or objects that have magnets to hold them in place or have lanyards or ropes that are used to hold them in place so that if they are dropped, they will not fall to the ground.

### BRIEF SUMMARY OF THE INVENTION

The present invention pertains to a ladder top. The ladder top comprises a surface. The ladder top comprises a front side flange extending down from the surface. The ladder top comprises a rear side flange extending down from the surface. The ladder top comprises a right side flange extending down from the surface having a right metal plate through which right fasteners extend into a right front rail and a right rear rail to attach the right front rail and the right rear rail to the right side flange. The ladder top comprises a left side flange extending down from the surface having a left metal plate through which left fasteners extend into a left front rail and a left rear rail to attach the left front rail and the left rear rail to the left side flange.

The present invention pertains to a ladder. The ladder comprises a front assembly having a right front rail and a left front rail in parallel in spaced relation with the right front rail, front rungs attached to the right front rail and the left front rail and disposed between the right front rail and the left front rail. The ladder comprises a rear assembly having a right rear rail and a left rear rail in parallel and space relation with the right rear rail, rear rungs attached to the right rear rail and the left rear rail and disposed between the right rear rail and the left rear rail. The ladder comprises a ladder top having a right side flange having a right metal plate through which right fasteners extend into the right front rail and the right rear rail to attach the right front rail and the right rear rail to the right side flange; a left side flange having a left metal plate through which left fasteners extend into the left front rail and the left rear rail to attach the left front rail and the left rear rail to the left side flange.

The present invention pertains to a ladder top. The ladder top comprises a surface. The ladder top comprises a front side flange extending down from the surface. The ladder top comprises a rear side flange extending down from the surface. The ladder top comprises a right side flange extending down from the surface having right fasteners which extend into a right front rail and a right rear rail to attach the right front rail and the right rear rail to the right side flange. The ladder top comprises a left side flange extending down from the surface having left fasteners which extend into a left front rail and a left rear rail to attach the left front rail and the left rear rail to the left side flange. The ladder top comprises passages at which hooks or carabiners attach to the ladder top.

The present invention pertains to a method of using a ladder. The method comprises the steps of climbing a ladder. There is the step of attaching a tool having a magnet to a right metal plate on a right side flange of a ladder top of the ladder.

The present invention pertains to a method of using a ladder. The method comprises the steps of climbing a ladder. There is the step of attaching a carabiner to a passage on a ladder top of the ladder.

The present invention pertains to a method for producing a ladder. The method comprises the steps of placing a right metal plate into a recess in a right side flange of a ladder top of the ladder. There is the step of attaching the right metal plate to the right side flange with right fasteners which extend through the right metal plate, the right side flange, a right front rail and a right rear rail.

### BRIEF DESCRIPTION OF THE FIGURES

FIG. 1A shows an overhead view of the ladder top.

FIG. 1B shows a front view of the ladder top.

FIG. 1C shows a rear view of the ladder top.

FIG. 1D shows a left side view of the ladder top.

FIG. 1E shows a right side view of the ladder top.

FIG. 2A shows a front right view of the ladder top with the metal plates and carabiner passages indicated.

FIG. 2B shows a front left perspective view of the ladder top with the metal plates and carabiner passages indicated.

FIG. 2C shows rear front perspective views of the ladder top with the metal plates and carabiner passages indicated.

FIG. 2D shows rear left perspective views of the ladder top with the metal plates and carabiner passages indicated.

FIG. 3 shows the ladder top in place on a step ladder.

FIG. 4 is a closeup view of FIG. 3.

FIG. 5 shows the right metal plate positioned alongside the bosses in the recess of the right side flange.

FIG. 6 shows the right metal plate positioned in the recess with the bosses extending through the holes in the right metal plate.

FIG. 7 shows the bosses flared over the right metal plate after heat is applied to them to cause them to melt over the right metal plate to hold the right metal plate to the right side flange.

### DETAILED DESCRIPTION OF THE INVENTION

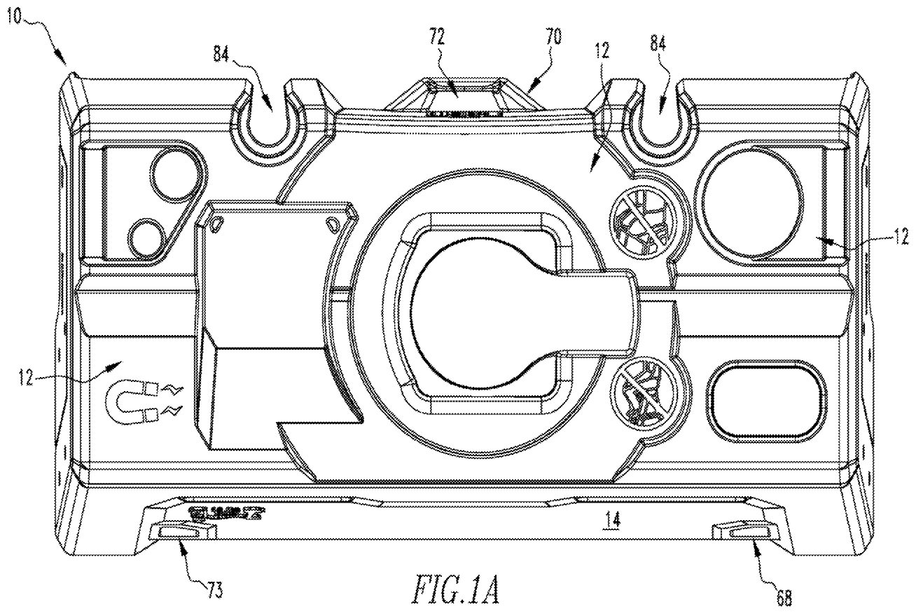

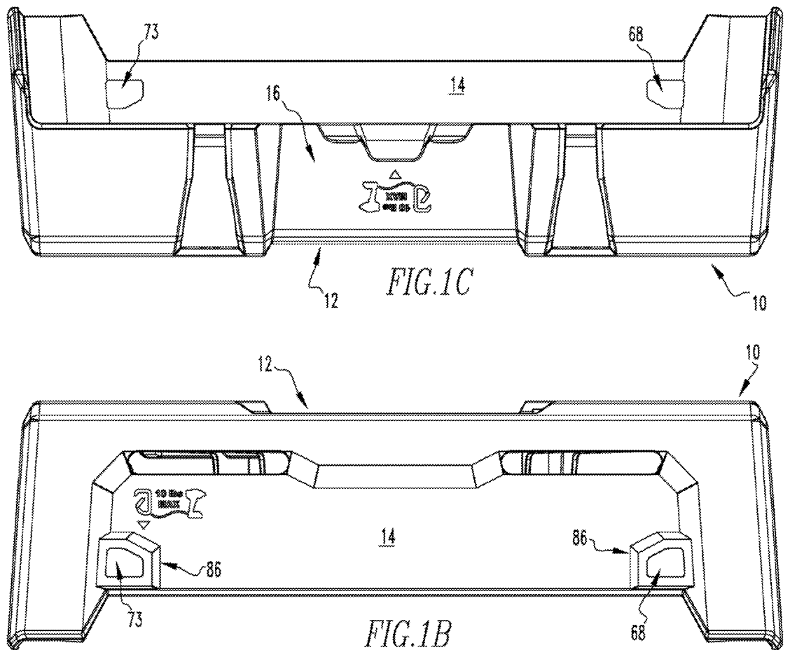

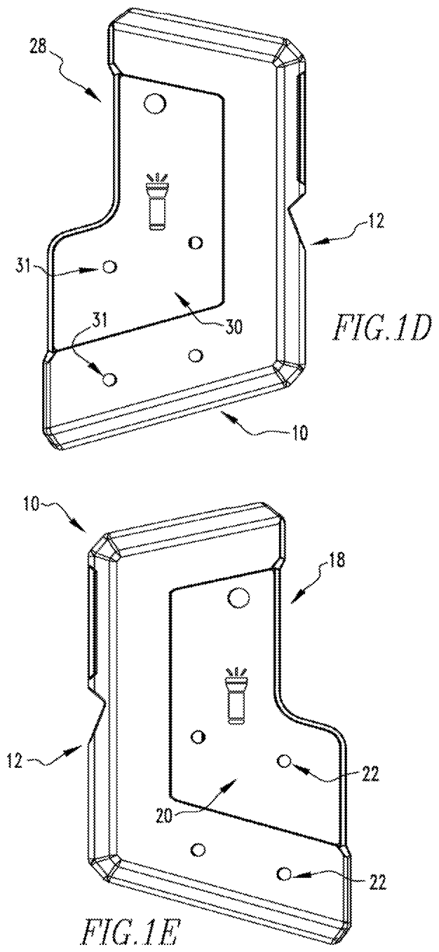

Referring now to the drawings wherein like reference numerals refer to similar or identical parts throughout the several views, and more specifically to FIGS. 1A-4 thereof, there is shown a ladder top 10. The ladder top 10 comprises a surface 12. The ladder top 10 comprises a front side flange 14 extending down from the surface 12. The ladder top 10 comprises a rear side flange 16 extending down from the surface 12. The ladder top 10 comprises a right side flange 18 extending down from the surface 12 having a right metal plate 20 through which right fasteners 22 extend into a right front rail 24 and a right rear rail 26 to attach the right front rail 24 and the right rear rail 26 to the right side flange 18. The ladder top 10 comprises a left side flange 28 extending down from the surface 12 having a left metal plate 30 through which left fasteners 32 extend into a left front rail 34 and a left rear rail 36 to attach the left front rail 34 and the left rear rail 36 to the left side flange 28. The right and left metal plates 20, 30 may each be between 1/16 of an inch and ⅜ of an inch thick.

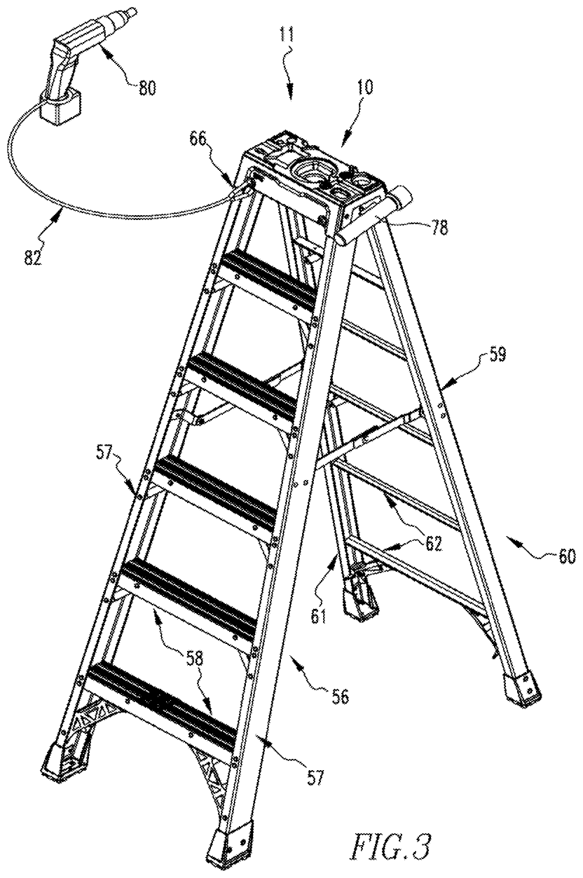

The right metal plate 20 may conform to the shape of the right side flange 18 and the left metal plate 30 may conform to the shape of the left side flange 28. The right side flange 18 may have an L shape and the left side flange 28 may have an L shape. The right metal plate 20 may have an L shape which fits with the L shape of the right side flange 18 and the left metal plate 30 may have an L shape which fits with the L shape of the left side flange 28. The right side flange 18 may have a long portion 74 and a short portion 76 which extends down from the long portion 74 to form the L shape. The right metal plate 20 may have a long portion 74 and a short portion 76 which extends down from the long portion 74 of the right metal plate 20 to form the L shape. The long portion 74 of the right metal plate 20 fits onto the long portion 74 of the right side flange 18 and the short portion 76 of the right metal plate 20 fits onto the short portion 76 of the right side flange 18. The left metal plate 30 may have a long portion 74 and a short portion 76 which extends down from the long portion 74 of the left metal plate 30 to form the L shape. The long portion 74 of the left metal plate 30 fits onto the long portion 74 of the left side flange 28 and the short portion 76 of the left metal plate 30 fits onto the short portion 76 of the left side flange 28. As shown in FIG. 3, the right front rail 24 attaches with right fasteners 22 or rivets to the inside of the long portion 74 and the short portion 76 of the right side flange 18 with at least one of the right fasteners 22 or rivets extending through the right metal plate 20 and the right side flange 18 and the right front rail 24. The right rear rail 26 rotatably attaches with a right fastener or rivet to only the inside of the long portion 74 of the right side flange 18 with the right fastener or rivet extending through the right metal plate 20 and the right side flange 18 and the right rear rail 26. The left front rail 34 attaches with left fasteners 32 or rivets to the inside of the long portion 74 and the short portion 76 of the left side flange 28 with at least one of the left fasteners 32 or rivets extending through the left metal plate 30 and the left side flange 28 and the left front rail 34. The left rear rail 36 rotatably attaches with a left fastener or a rivet to only the inside of the long portion 74 of the left side flange 28 with the left fastener or rivet extending through the left metal plate 30 and the left side flange 28 and the left rear rail 36. The long portion 74 of the right and left metal plates 20, 30 may each be at least 2 inches long.

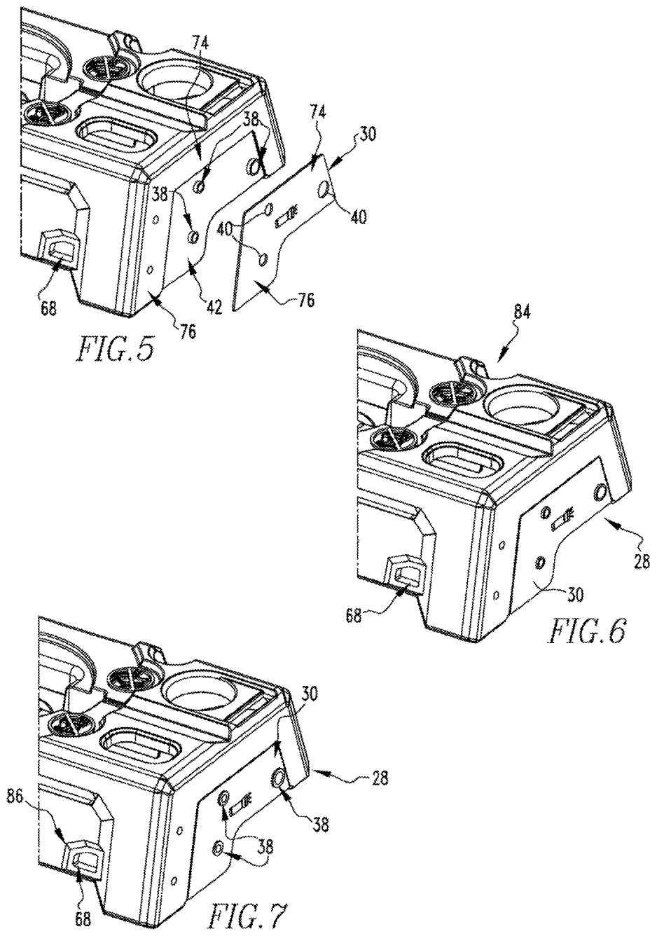

Referring to FIGS. 5-7, the right side flange 18 may have bosses 38 and the right metal plate 20 may have holes 40 through which the bosses 38 extend to hold the right metal plate 20 to the right side flange 18. The right fasteners 22 extend through the holes 40 of the right metal plate 20 and the bosses 38. The right side flange 18 may have a recess 42 in which the right metal plate 20 is disposed. The bosses 38 are disposed in the recess 42.

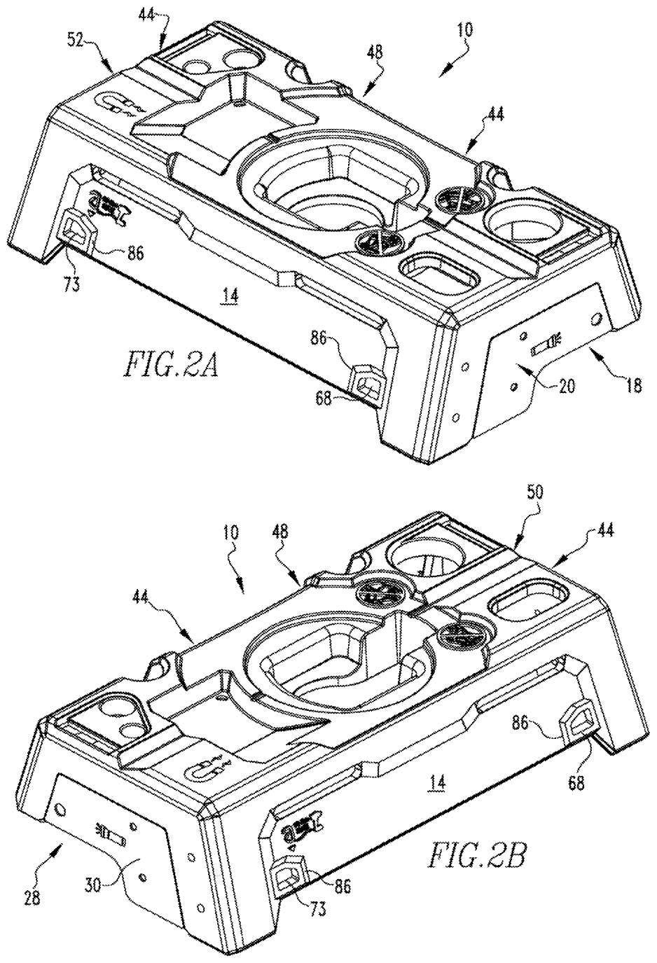

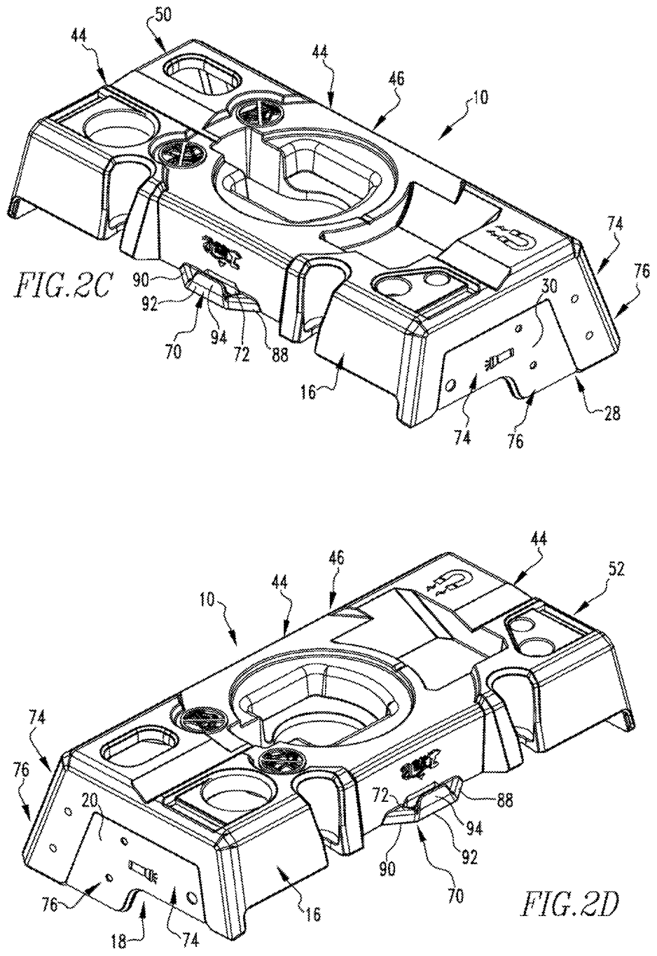

The surface 12 may have a perimeter 44 and a front edge 46, a rear edge 48, a right edge 50 extending between the front edge 46 and the rear edge 48, and a left edge 52 extending between the front edge 46 and the rear edge 48, as shown in FIGS. 1A-2D. The front side flange 14 extending down from the front edge 46, the rear side flange 16 extending down from the rear edge 48, the right side flange 18 extending down from the right edge 50 and the left side flange 28 extending down from the left edge 52. The surface 12 and the front side flange 14 and the rear side flange 16 and the right side flange 18 and the left side flange 28 may be a single continuous piece of plastic. The ladder top 10 may include passages 54 through which hooks 64 or carabiners 66 attach to the ladder top 10. The ladder top 10 may have one or more lasso slots 84 in the perimeter 44 and pockets and openings in the surface 12 to hold screw drivers, pliers, wrenches, brushes, cans, pipes, tubes, drills, screws, nuts, bolts and/or pins.

The present invention pertains to a ladder 11, as shown in FIGS. 1A-3. The ladder 11 comprises a front assembly 56 having a right front rail 24 and a left front rail 34 in parallel in spaced relation with the right front rail 24, front rungs 58 attached to the right front rail 24 and the left front rail 34 and disposed between the right front rail 24 and the left front rail 34. The ladder 11 comprises a rear assembly 60 having a right rear rail 26 and a left rear rail 36 in parallel and space relation with the right rear rail 26, rear rungs 62 attached to the right rear rail 26 and the left rear rail 36 and disposed between the right rear rail 26 and the left rear rail 36. The ladder 11 comprises a ladder top 10 having a right side flange 18 having a right metal plate 20 through which right fasteners 22 extend directly into the right front rail 24 and directly into the right rear rail 26 to permanently attach the right front rail 24 and the right rear rail 26 to the right side flange 18. The ladder top 10 having a left side flange 28 having a left metal plate 30 through which left fasteners 32 extend directly into the left front rail 34 and the left rear rail 36 to permanently attach the left front rail 34 and the left rear rail 36 to the left side flange 28.

The present invention pertains to a ladder top 10. The ladder top 10 comprises a surface 12. The ladder top 10 comprises a front side flange 14 extending down from the surface 12. The ladder top 10 comprises a rear side flange 16 extending down from the surface 12. The ladder top 10 comprises a right side flange 18 extending down from the surface 12 having right fasteners 22 which extend into a right front rail 24 and a right rear rail 26 to attach the right front rail 24 and the right rear rail 26 to the right side flange 18. The ladder top 10 comprises a left side flange 28 extending down from the surface 12 having left fasteners 32 which extend into a left front rail 34 and a left rear rail 36 to attach the left front rail 34 and the left rear rail 36 to the left side flange 28. The ladder top 10 comprises passages 54 at which carabiners 66 attach to the ladder top 10, as shown in FIGS. 1B, 2A, 2B and 3. The passages 54 have a closed circumference and may have a reinforcing wall 86 about the circumference which extends from the respective flange they are in. There may be a first passage 68 with a reinforcing wall 86 about its circumference at the front side flange 14 and a third passage 73 with a reinforcing wall 86 about its circumference also at the front side flange 14 located adjacent the bottom of the front side flange 14. The reinforcing wall 86 is part of the one-piece ladder top 10.

The ladder top 10 may include a paint bucket hook 70 at the back side flange, and there is a second passage 72 at the paint bucket hook 70. The paint bucket hook 70 is formed by a first strut 88 extending out from the rear side flange 16 and a second strut 90 extending out from the rear side flange 16 adjacent the first strut 88, as shown in FIGS. 2C and 2D. There is a bar 92 to which the first strut 88 and second strut 90 are attached. The bar 92 is in parallel with the rear side flange 16 and offset outwards from the rear side flange 16 by the first and second struts 88, 90. The bar 92 and the first and second struts 88, 90 form and define the second passage 72 between them. The bar 92 has a lip 94 which extends upwards from the bar 92. The bar 92 with the lip 94 and the first and second struts 88, 90 form the paint bucket hook 70. The handle of a paint bucket hangs on the paint bucket hook 70 with the lip 94 catching the handle and preventing the handle from sliding off the paint bucket hook 70. The first and second struts 88, 90 and the bar 92 and the lip 94 are all part of the one-piece ladder top 10.

The right side flange 18 may have a right metal plate 20 through which the right fasteners 22 extend into the right front rail 24 and the right rear rail 26 to attach the right front rail 24 and the right rear rail 26 to the right side flange 18; and the left side flange 28 may have a left metal plate 30 through which the left fasteners 32 extend into the left front rail 34 and the left rear rail 36 to attach the left front rail 34 and the left rear rail 36 to the left side flange 28.

The present invention pertains to a ladder 11, as shown in FIGS. 1A-3. The ladder 11 comprises a front assembly 56 having a right front rail 24 and a left front rail 34 in parallel and spaced relation with the right front rail 24, front rungs 58 attached to the right front rail 24 and the left front rail 34 and disposed between the right front rail 24 and the left front rail 34. The ladder 11 comprises a rear assembly 60 having a right rear rail 26 and a left rear rail 36 in parallel and space relation with the right rear rail 26, rear rungs 62 attached to the right rear rail 26 and the left rear rail 36 and disposed between the right rear rail 26 and the left rear rail 36. The ladder 11 comprises a ladder top 10 having a right side flange 18 through which right fasteners 22 extend into the right front rail 24 and the right rear rail 26 to permanently attach the right front rail 24 and the right rear rail 26 to the right side flange 18; a left side flange 28 through which left fasteners 32 extend into the left front rail 34 and the left rear rail 36 to permanently attach the left front rail 34 and the left rear rail 36 to the left side flange 28. The ladder 11 comprises passages 54 at which carabiners 66 attach to the ladder top 10.

The present invention pertains to a method of using a ladder 11. The method comprises the steps of climbing a ladder 11. There is the step of attaching a tool 80 having a magnet to a right metal plate 20 on a right side flange 18 of a ladder top 10 of the ladder 11.

The present invention pertains to a method of using a ladder 11. The method comprises the steps of climbing a ladder 11. There is the step of attaching a carabiner to a passage on a ladder top 10 of the ladder 11.

The present invention pertains to a method for producing a ladder 11. The method comprises the steps of placing a right metal plate 20 into a recess 42 in a right side flange 18 of a ladder top 10 of the ladder 11. There is the step of attaching the right metal plate 20 to the right side flange 18 with right fasteners 22 which extend through the right metal plate 20, the right side flange 18, a right front rail 24 and a right rear rail 26.

This invention is a molded plastic ladder top 10 which has metal plates attached to the sides which serve to strengthen the top to rail connection and provide a foundation for the magnetic attachment of tools such as flashlights, etc. Tools, lights, etc. with magnetic bases can be conveniently attached to the metal plates on the ladder top 10. The metal plates also strengthen the ladder 11 in the rail to top connections.

In addition, the top has passages 54 in the front face and in the paint bucket hook 70 which serve as attachment points for hooks 64 or carabiners 66 such as those used for safety lanyards 82 on tools such as electric drills. Holes 40 for the attachment of tool 80 lanyards provide for greater safety when working on the ladder 11.

FIGS. 1A-1E show multiple projection views of the ladder top 10. The top is molded of plastic. Metal plates are located in recesses 42 at both sides of the top. Passages 54 for carabiner attachment are located in the front face and in the conventional bucket hook on the rear face.

FIGS. 2A-2D show front and rear perspective views of the ladder top 10 with the metal plates and carabiner passages 54 indicated.

FIG. 3 shows the ladder top 10 in place on a step ladder 11. An electric drill is shown attached to the ladder top 10 with a tool lanyard and carabiner. A flashlight 78 is shown magnetically attached to a metal plate.

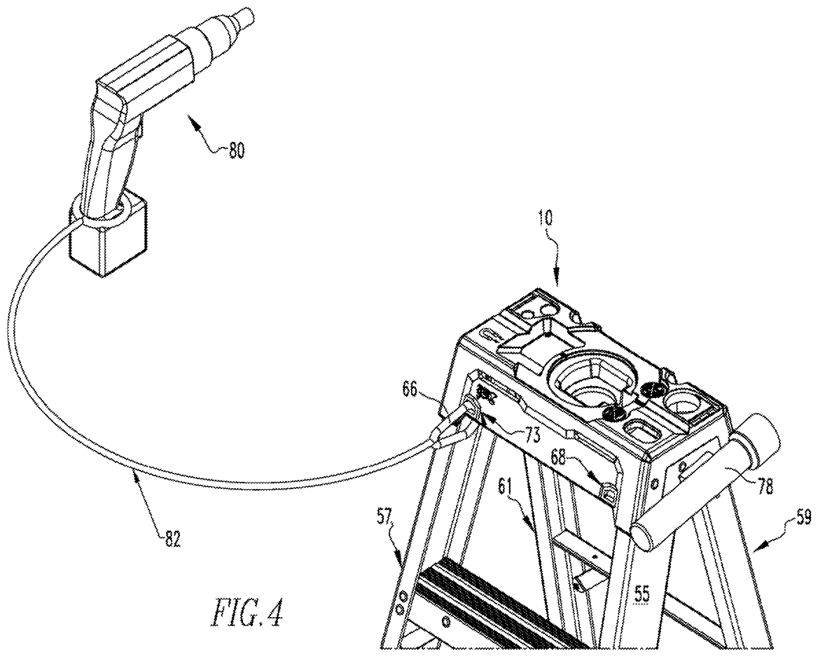

FIG. 4 is a closeup view of FIG. 3. The carabiner is shown attached to one of the carabiner holes 40. The magnetic base of the flashlight 78 can be seen stuck to the metal plate.

FIG. 5 shows the right metal plate 20 positioned alongside the bosses 38 in the recess 42 of the right side flange 18. FIG. 6 shows the right metal plate 20 positioned in the recess 42 with the bosses 38 extending through the holes 40 in the right metal plate 20. FIG. 7 shows the bosses 38 flared over the right metal plate 20 after heat is applied to them to cause them to melt over the right metal plate 20 to hold the right metal plate 20 to the right side flange 18. With the right metal plate 20 held in position to the right side flange 18, fasteners such as rivets or bolts are then extended through the holes 40 and into the right front and rear rails to attach the right front and rear rails to the right side flange 18 without having to hold the right metal plate 20 to the right side flange 18. Alternatively, if it is so desired, bosses 38 do not need to be used and the right metal plate 20 is held in the recess 42 so the holes 40 of the right metal plate 20 aligned with the holes 40 in the right side flange 18 so fasteners can be inserted through these holes 40 to attach the right and rear front rails to the right side flange 18 and right metal plate 20.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1-20. (canceled)

21. A ladder top comprising:
a ladder top body for mounting to upper end portions of one or more ladder rails;
the ladder top body including at least one attachment slot for securing an accessory to the ladder top body; and
a metal plate secured to the ladder top body.

22. The ladder top of claim 21 wherein the metal plate includes one or more attachment openings, the metal plate secured to the ladder top body via the one or more attachment openings.

23. The ladder top of claim 22 wherein the ladder top body includes a sidewall having bosses that extend through the attachment openings of the metal plate.

24. The ladder top of claim 21 further comprising fasteners securing the metal plate to the ladder top body.

25. The ladder top of claim 21 wherein the at least one attachment slot includes a first attachment slot and a second attachment slot on one side of the ladder top body, the first attachment slot spaced apart from the second attachment slot.

26. The ladder top of claim 21 wherein the ladder top body includes a first side and a second side different than the first side,
the at least one attachment slot being disposed on the first side of the ladder top body and the metal plate secured to the second side of the ladder top body.

27. The ladder top of claim 21 wherein the metal plate includes a first metal plate and a second metal plate secured on opposite sides of the ladder top body.

28. The ladder top of claim 27 wherein the ladder top body is formed of a single piece of plastic;
wherein at least one attachment slot of the ladder top body includes a plurality of attachment slots disposed along a side of the ladder top body extending between the sides with the first and second metal plates; and
wherein the ladder top body includes a hook on the side of the ladder top body between a first attachment slot and a second attachment slot of the plurality of attachment slots.

29. The ladder top of claim 21 wherein the ladder top body includes a sidewall defining a recess, the metal plate at least partially received in the recess of the sidewall.

30. The ladder top of claim 21 wherein the ladder top body includes a sidewall having an accessory attachment opening for removably attaching an item to the ladder top.

31. The ladder top of claim 30 wherein the ladder top body includes a reinforcing portion about the accessory attachment opening.

32. The ladder top of claim 21 wherein the ladder top body includes a front, a rear, a top, and a bottom,
wherein the metal plate includes an elongate first portion extending between the front and the rear of the ladder top body, and a second portion extending from the first portion of the metal plate toward the bottom of the ladder top body.

33. The ladder top of claim 21 wherein the ladder top body includes an upper wall defining an elongate opening and a recess extending about at least a portion of the elongate opening.

34. A ladder comprising:
a first rail, a second rail, and a plurality of rungs extending between the first rail and the second rail; and
a ladder top mounted to upper end portions of the first and second rails, the ladder top including:
a ladder top body;
a first metal plate secured to the ladder top body and the first rail; and
a second metal plate secured to the ladder top body and the second rail.

35. The ladder of claim 34 wherein the ladder top body includes at least one attachment slot for securing an accessory to the ladder top body.

36. The ladder of claim 34 wherein the first metal plate includes one or more attachment openings, the metal plate secured to the ladder top body and the first rail via the one or more attachment openings.

37. The ladder of claim 36 wherein the ladder top body includes a first sidewall having bosses that extend through the attachment openings of the first metal plate.

38. The ladder of claim 34 further comprising fasteners securing the first metal plate to the first rail and the second metal plate to the second rail.

39. The ladder of claim 34 further comprising a third rail, a fourth rail, and a second plurality of rungs extending between the third rail and the fourth rail,
wherein the first metal plate secured to the third rail; and
wherein the second metal plate is secured to the fourth rail.

40. The ladder of claim 34 wherein the ladder top body includes first sidewall including a first recess and a second sidewall including a second recess, wherein the first metal plate is at least partially received in the first recess of the ladder top body and the second metal plate is at least partially received in the second recess of the ladder top body.
